(19) United States
(12) Patent Application Publication
(10) Pub. No.: US 2005/0232458 A1
(43) Pub. Date: Oct. 20, 2005

(54) Speaker-use diaphragm and speaker

(75) Inventor: Satoshi Hachiya, Yamagata (JP)

Correspondence Address: MORGAN LEWIS & BOCKIUS LLP, 1111 PENNSYLVANIA AVENUE NW, WASHINGTON, DC, 20004, US

(73) Assignees: PIONEER CORPORATION; TOHOKU PIONEER CORPORATION

(21) Appl. No.: 11/105,570

(22) Filed: Apr. 14, 2005

(30) Foreign Application Priority Data
Apr. 15, 2004 (JP) P 2004-120447

(51) Int. Cl. H04R 25/00

(52) U.S. Cl. 381/426; 381/428

(57) ABSTRACT

A diaphragm is manufactured by impregnating a woven cloth of aramid fiber with thermosetting resin and thereafter performing heat-molding with the woven cloth sandwiched in a predetermined die at a predetermined temperature so that the woven cloth is molded into a predetermined shape. In the woven cloth, each of warps and wefts to be woven is composed of two threads woven to be arranged in parallel to provide a belt-like width.

The present disclosure relates to the subject matter contained in Japanese Patent Application No. 2004-120447 filed on Apr. 15, 2004, which is incorporated herein by reference in its entirety.

### BACKGROUND OF THE INVENTION

1. Field of the Invention

This invention relates to a diaphragm for use in a speaker (hereinafter also referred to a speaker-use diaphragm) and a speaker using the diaphragm.

2. Description of the Related Art

FIG. 1 shows the structure of a speaker in a related art.

A speaker 1 includes a magnetic circuit 3, a frame 5 to the rear of which the magnetic circuit 3 is attached, a cone-shaped diaphragm 9 in which a roll-shaped edge 7 on the outer edge is secured to an edge supporting portion 5a at the front of the frame 5 and a voice coil 12 wound around a cylindrical voice coil bobbin 11.

The magnetic circuit 3 includes a yoke 15 composed of a disk-shaped plate 15a and a cylindrical center pole 15b projected from the center thereof, a ring-shaped magnet 16 loosely fit on the outer periphery of the center pole 15b and a ring-shaped top plate 17 loosely fit on the tip side of the center pole 15b so as to sandwich the magnet 16 between itself and the plate 15a.

The gap between the inner periphery of the top plate 17 and the center pole 15b serves as a magnetic gap 19 where the voice coil 12 is arranged.

At the center of the diaphragm 9, an opening 9a through which the voice coil bobbin 11 is passed is formed. The edge 7 connected to the outer edge of the diaphragm 9 is secured to the edge supporting portion 5a in such a fashion that an attaching flange attached to the outer periphery of the edge 7 is sandwiched between a ring-shaped gasket 21 put on the edge supporting portion 5a and the edge supporting portion 5a. The inner edge of the diaphragm 9 which forms the opening 9a is secured to the outer periphery of the voice coil bobbin 11 passed through the opening 9a using, e.g., adhesive.

Further, a dust cap 23 is put on the center of the diaphragm 9. The dust cap 23 covers the front of the voice coil bobbin 11 to prevent invasion of dust into the magnetic gap 19.

The cylindrical voice coil bobbin 11 is loosely fit on the outer periphery of the center pole 15b so that it is axially movable. The cylindrical voice coil bobbin 11 is also elastically supported by the frame 5 through a damper 25 so that its axial movement is limited. The diaphragm 9 is vibrated by the reciprocating vibration of the voice coil bobbin 11 owing to an input signal to the voice coil 12, thus making acoustic reproduction.

The damper 25 is formed in a corrugation structure with convexities and concavities alternately arranged in a radial direction, and called a corrugation damper.

The outer edge of the damper 25 is secured to a damper supporting portion 5b of the frame 5 whereas the inner edge of the damper 25 is secured to the outer periphery of the voice coil bobbin 11. Thus, the radial displacement of the voice coil bobbin 11 is limited. In addition, when the diaphragm 9 is driven, the vibration energy is absorbed by deformation of the corrugation to control the vibration of the diaphragm 9.

Meanwhile, in recent years, with development in a large output of a speaker unit, as a high-rigidity and high-performance speaker-use diaphragm which can endure the large output, there has been proposed a speaker-use diaphragm manufactured by impregnating a woven cloth of aramid fiber with thermosetting resin and thereafter performing heat-molding so that the woven cloth is molded into a predetermined shape (e.g., cone shape or dome shape) (see, e.g., JP-A-2001-169387 and JP-A-11-285094).

FIGS. 2A, 2B, 3A and 3B show weaving structures of woven cloth used for the speaker-use diaphragm described above. Any woven cloth illustrated is a plane cloth with warps and wefts alternately woven one by one, respectively.

FIGS. 2A and 2B show a coarse-woven cloth of thick threads used as warps 31 and wefts 32. FIGS. 3A and 3B show a close-woven cloth of thin threads used as warps 33 and wefts 34.

### SUMMARY OF THE INVENTION

Meanwhile, in the speaker-use diaphragm formed of the woven cloth, the texture of the woven cloth can be visually recognized. Thus the size of the texture of the woven cloth greatly influences the design of a product.

However, in the case of the plane cloth with warps and wefts alternately woven one by one, respectively, as in the related art technique, as seen from FIGS. 2A, 2B, 3A and 3B, the size of the texture, i.e., the thickness of the cloth t1, t2 is determined by the thickness of the threads used.

Therefore, for example, if it is desired to make the coarse texture so that the texture is conspicuous, the thick threads must be employed. Thus, the thickness t1 of the cloth is increased thereby to increase the weight of the cloth. This gives rise to a problem of increased loss of vibration propagation, for example.

Such increased loss of vibration propagation will deteriorate the output efficiency of a speaker and also the response thereof. This causes attenuation in the resolution and clarity of sound.

According to an aspect of the invention, there is provided a speaker-use diaphragm including: a woven cloth having warps and wefts, the woven cloth being impregnated with thermosetting resin and heat-molded to have a predetermined shape, wherein each of the warps and wefts woven in the woven cloth is composed of a plurality of threads arranged in parallel.

### BRIEF DESCRIPTION OF THE DRAWINGS

FIG. 1 is a sectional view showing the configuration of a speaker in the related art;

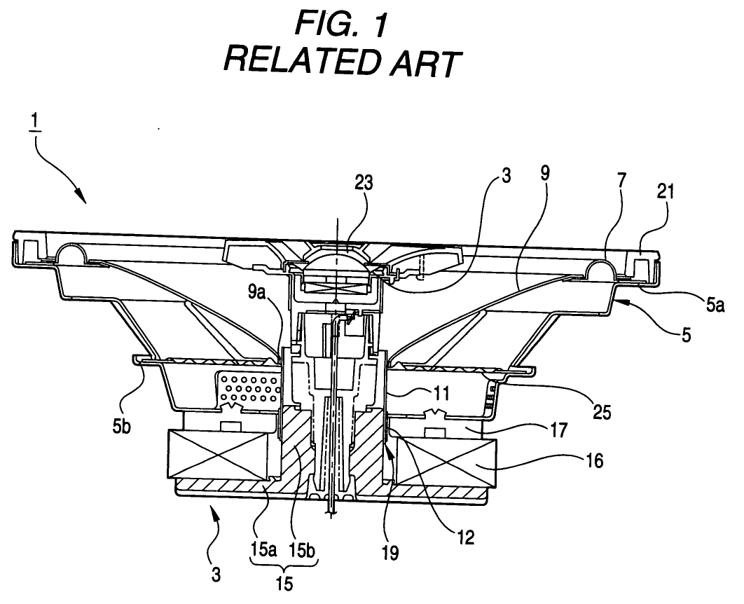

FIGS. 2A and 2B are views for explaining the weaving structure of a woven cloth of a speaker-use diaphragm used in the speaker shown in FIG. 1;

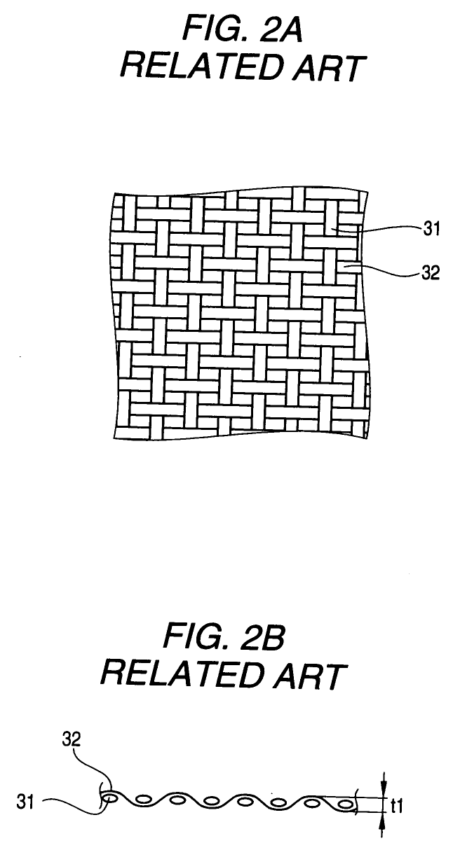

FIGS. 3A and 3B are views for explaining the weaving structure of another woven cloth in the related art;

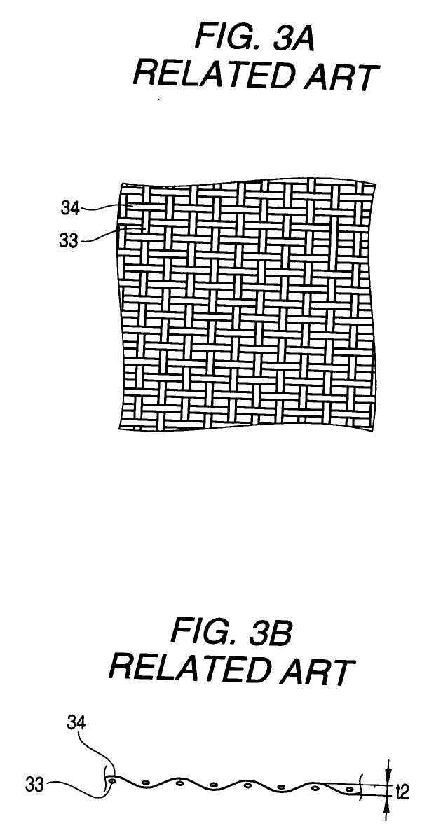

FIG. 4 is a sectional view showing the configuration of a speaker according to an embodiment of this invention;

FIGS. 5A and 5B are views for explaining the weaving structure of a woven cloth of a speaker-use diaphragm used in the speaker shown in FIG. 4; and

FIGS. 6A and 6B are views for explaining the weaving structure of a woven cloth according to another embodiment of a speaker-use diaphragm shown in FIG. 4.

### DETAILED DESCRIPTION OF THE PREFFERED EMBODIMENTS

An explanation will be given of an embodiment of a speaker-use diaphragm and a speaker according to this invention.

This invention provides a speaker-use diaphragm manufactured by impregnating a woven cloth of aramid fiber with thermosetting resin and thereafter performing heat-molding so that the woven cloth is molded into a predetermined shape, wherein each of warps and wefts woven in the woven cloth is composed of a plurality of threads arranged in parallel.

Namely, each of the warps and wefts used to make a woven cloth is composed of a plurality of threads arranged in parallel. For this reason, as compared with the conventional plane cloth within warps and wefts alternately woven one by one, respectively, without changing the thickness of the threads, a cloth with the texture enlarged in plural times vertically and horizontally can be obtained.

Thus, the woven cloth of fiber which is a raw material of the speaker-use diaphragm can be finished thin in thickness and light in weight while assuring texture with desired coarseness required from the viewpoint of design.

The threads constituting the warps and wefts in this invention may be at least two mixed threads of different substances.

In this case, if the two threads arranged in parallel as the warps or wefts are mixed threads of different substances, for example one is made of meta-aramid fiber and the other is made of para-aramid fiber, resonance can be dispersed to eliminate unnecessary vibration, thus realizing clear acoustic reproduction with improved S/N ratio.

In the speaker using the speaker-use diaphragm having the configuration described above, it is possible to prevent the weight of woven cloth leading to vibration propagation loss from being increased, thereby improving the output efficiency and response of the speaker.

Now referring to the drawings, a detailed explanation will be given of a speaker-use diaphragm and speaker according to an embodiment of this invention.

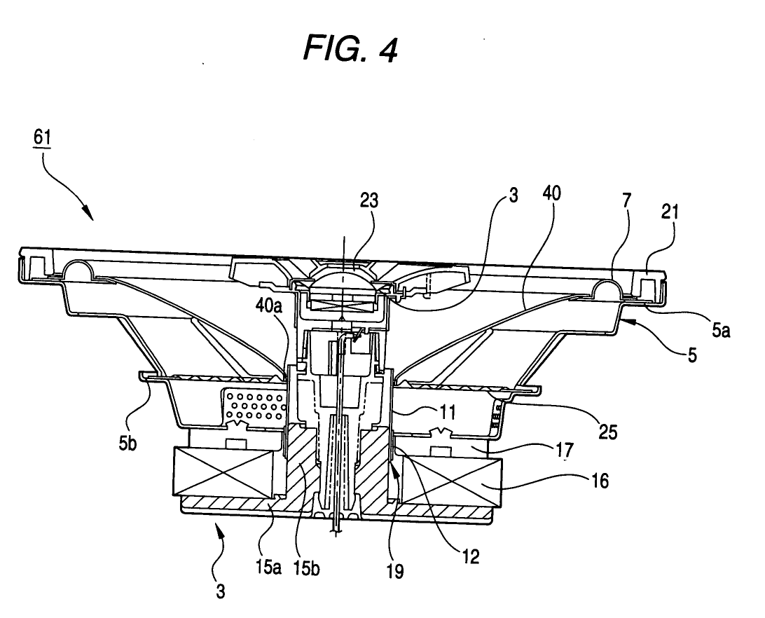

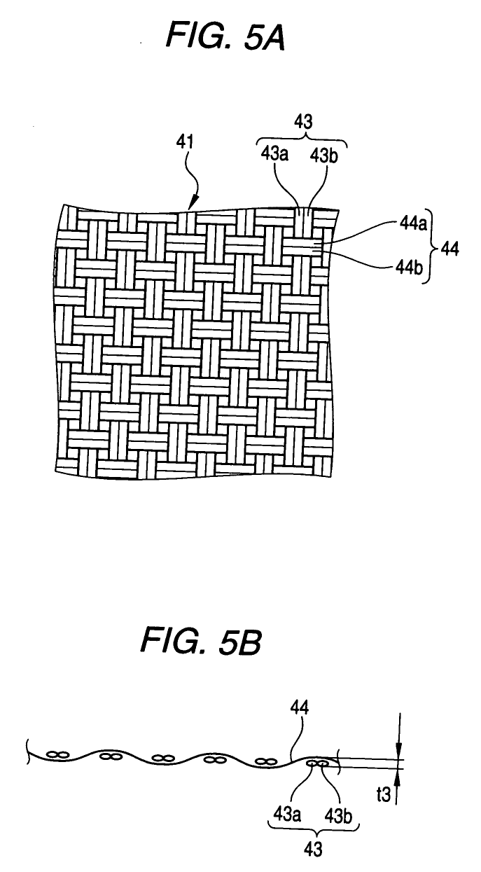

FIG. 4 is a sectional view showing the configuration of the speaker according to an embodiment of this invention. FIGS. 5A and 5B are a plan view and a sectional view showing an embodiment of a weaving structure of the woven cloth used for the speaker-use diaphragm shown in FIG. 4.

A speaker 61 shown in FIG. 4 includes a magnetic circuit 3, a frame 5 to the rear of which the magnetic circuit 3 is attached, a cone-shaped diaphragm (speaker-use diaphragm) 40 in which a roll-shaped edge 7 on the outer edge is secured to an edge supporting portion 5a at the front of the frame 5 and a voice coil 12 wound around a cylindrical voice coil bobbin 11.

The magnetic circuit 3 includes a yoke 15 composed of a disk-shaped plate 15a and a cylindrical center pole 15b projected from the center thereof, a ring-shaped magnet 16 loosely fit on the outer periphery of the center pole 15b and a ring-shaped top plate 17 loosely fit on the tip side of the center pole 15b so as to sandwich the magnet 16 between itself and the plate 15a.

The gap between the inner periphery of the top plate 17 and the center pole 15b serves as a magnetic gap 19 where the voice coil 12 is arranged.

At the center of the diaphragm 40, an opening 40a through which the voice coil bobbin 11 is passed is formed. The edge 7 connected to the outer edge of the diaphragm 40 is secured to the edge supporting portion 5a in such a fashion that an attaching flange attached to the outer periphery of the edge 7 is sandwiched between a ring-shaped gasket 21 put on the edge supporting portion 5a and the edge supporting portion 5a. The inner edge of the diaphragm 40 which forms the opening 40a is secured to the outer periphery of the voice coil bobbin 11 passed through the opening 40a using, e.g., adhesive.

Further, a dust cap 23 is put on the center of the diaphragm 40. The dust cap 23 covers the front of the voice coil bobbin 11 to prevent invasion of dust into the magnetic gap 19.

The cylindrical voice coil bobbin 11 is loosely fit on the outer periphery of the center pole 15b so that it is axially movable. The cylindrical voice coil bobbin 11 is also elastically supported by the frame 5 through a damper 25 so that its axial movement is limited. The diaphragm 40 is vibrated by the reciprocating vibration of the voice coil bobbin 11 owing to an input signal to the voice coil 12, thus making acoustic reproduction.

The outer edge of the damper 25 is secured to a damper supporting portion 5b of the frame 5 whereas the inner edge of the damper 25 is secured to the outer periphery of the voice coil bobbin 11. Thus, the radial displacement of the voice coil bobbin 11 is limited. In addition, when the diaphragm 40 is driven, the vibration energy is absorbed by deformation of the corrugation to control the vibration of the diaphragm 40.

The diaphragm 40 according to this embodiment is manufactured by impregnating woven cloth 41 with thermosetting resin and thereafter heat-molding the woven cloth 41 sandwiched in a predetermined die at a predetermined temperature so that it is molded into a cone shape. The diaphragm 40 according to this embodiment is characterized by the weaving structure of the woven cloth 41 of fiber such as aramid fiber.

In the woven cloth 41 shown in FIGS. 5A and 5B, each of warps 43 to be woven is composed of two threads 43a, 43b of aramid fiber twisted to have a predetermined diameter, which are woven to be arranged in parallel to provide a belt-like width. Likewise, each of wefts 44 is composed of threads 44a, 44b of aramid fiber twisted to have a predetermined diameter, which are woven to be arranged in parallel to provide a belt-like width.

These warps 43 and wefts 44 are alternately woven to provide a plane cloth to be finished as a woven cloth 41.

The two threads which constitutes these belt-like warp 43 and weft 44 are made of different substances. For example, the one thread 43a, 44a is made of a meta-aramid fiber whereas the other thread 43b, 44b is made of a para-aramid fiber.

A typical example of the meta-aramid fiber is polymetaphenylene isophthal amide.

A typical example of the para-aramid fiber is an aromatic polyamide fiber such as coparaphenylene-3,4′-oxydiphenylenetelephthalamide or PPTA (polyphenylenetelephthalamide).

Incidentally, the fiber of the woven cloth for the speaker-use diaphragm according to this invention should not be limited to the aramid fiber described above, but may be carbon fiber, PBO (polyparaphenylene-benzobis-oxazole) fiber, glass fiber, PET (polyethylene-terephthalate) fiber, PEN (polyethylene naphthalate), etc.

The diaphragm 40 is manufactured by impregnating the woven cloth 41 with thermosetting resin and thereafter performing heat-molding so that the woven cloth 41 is molded into a predetermined shape. In such a diaphragm 40, the warp 43 and weft 44 of the woven cloth 41 are woven, respectively so that their two threads 43a, 43b and 44a, 44b are arranged in parallel. For this reason, as compared with the conventional plane cloth with warps and wefts are alternately woven one by one, respectively, without changing the thickness of the threads, the woven cloth 41 with the texture enlarged about twice vertically and horizontally can be obtained. On the other hand, the thickness t3 of the woven cloth 41 composed of the warp 43 and weft 44 superposed may be equal to the case where a single thread is plane-woven for both warp and weft.

As the warp 43 and weft 44 used to form the woven cloth 41, two threads are arranged in parallel so that the coarseness of the texture of the woven cloth 41 can be made twice. This makes the texture conspicuous, thereby improving the designing effect.

In addition, the thickness t3 of the woven cloth 41 is identical to the case where a single thread is plane-woven for the warp and weft. Thus, the woven cloth 41 can be finished thin in thickness and light in weight.

Accordingly, in the speaker 61 according to this embodiment it is possible to prevent the weight of the woven cloth 41 leading to vibration propagation loss from being increased, thereby improving the output efficiency and response of the speaker.

Further, in the case of the woven cloth 41 according to this embodiment since the two threads arranged in parallel as the warp 43 and weft 44 are mixed threads of different substances, for example one is made of meta-aramid fiber and the other is made of para-aramid fiber, resonance can be dispersed during the vibration propagation to eliminate unnecessary vibration, thus realizing clear acoustic reproduction with improved S/N ratio.

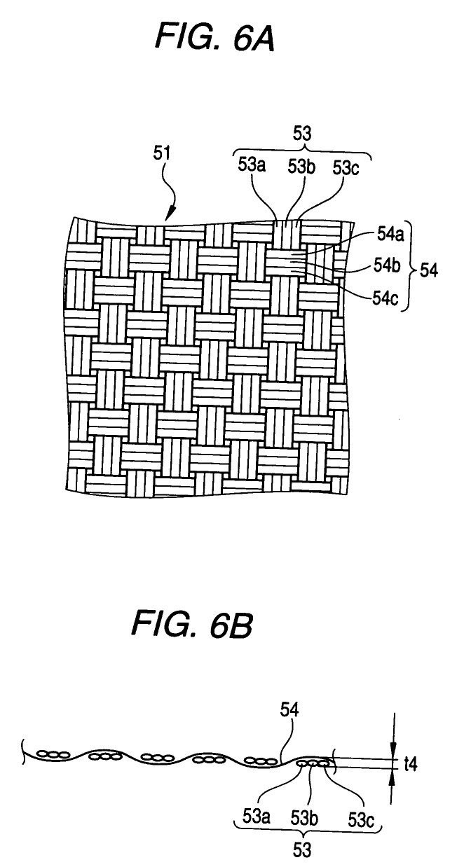

FIGS. 6A and 6B are a plan view and a sectional view showing the weaving structure of a woven cloth of the speaker-use diaphragm according to another embodiment of this invention.

In the woven cloth 51 shown in FIG. 6A, each of warps 53 to be woven is composed of three threads 53a, 53b, 53c of aramid fiber twisted to have a predetermined diameter, which are woven to be arranged in parallel to provide a belt-like width. Likewise, each of wefts 54 is composed of three threads 54a, 54b, 54c of aramid fiber twisted to have a predetermined diameter, which are woven to be arranged in parallel to provide a belt-like width.

These warp 53 and weft 54 are alternately woven to provide a plane cloth to be finished as a woven cloth 51.

The three threads which constitutes these belt-like warp 53 and weft 54 are made of different substances. For example, the first thread 53a, 54a of the three threads is made of polymetaphenylene isophthal amide which is meta-aramid fiber; the second 53b, 54b is made of coparaphenylene-3,4′-oxydiphenylenetelephthalamide which is para-aramid fiber; and the third thread 53c, 54c is made of an aromatic polyamide fiber which is para-aramid fiber.

The speaker-use diaphragm described above is manufactured by impregnating the woven cloth 51 with thermosetting resin and thereafter performing heat-molding so that the woven cloth 51 is molded into a predetermined shape. In such a diaphragm, the warp 53 and weft 54 of the woven cloth 51 are woven, respectively so that their three threads 53a, 53b, 53c and 54a, 54b, 54c are arranged in parallel. For this reason, as compared with the conventional plane cloth with warps and wefts alternately woven one by one, respectively, without changing the thickness of the threads, the woven cloth 51 with the texture enlarged about three times vertically and horizontally can be obtained. On the other hand, the thickness t4 of the woven cloth 51 composed of the warp 53 and weft 54 superposed may be equal to the case where a single thread is plane-woven for both warp and weft.

As the warp 53 and weft 54 used to form the woven cloth 51, three threads are arranged in parallel so that the coarseness of the texture of the woven cloth 51 can be made three times. This makes the texture conspicuous, thereby improving the designing effect.

In addition, the thickness t4 of the woven cloth 51 is identical to the case where a single thread is plane-woven for the warp and weft. Thus, the woven cloth 51 can be finished thin in thickness and light in weight.

Accordingly, it is possible to prevent the weight of woven cloth 51 leading to vibration propagation loss from being increased, thereby improving the output efficiency and response of the speaker.

Further, in the case of the woven cloth 51 according to this embodiment, since the three threads arranged in parallel as the warp 53 and weft 54 are mixed threads of different substances, resonance can be dispersed during the vibration propagation to eliminate unnecessary vibration, thus realizing clear acoustic reproduction with improved S/N ratio.

Additionally, the speaker-use diaphragm and the fiber, woven cloth and speaker-use diaphragm in the speaker according to this invention should not be limited to those in the embodiments described above. They may be realized in various forms on the basis of the spirit of this invention.

For example, the number of threads used to make the warp and weft should not be limited to two or three proposed in the embodiments described above. Any number of four or more threads may be used to make the warp and weft. By changing the number of threads arranged in parallel, without changing the thickness of the woven cloth, the texture can be set with any coarseness. Thus, from the viewpoint of design, the coarseness of the texture can be set at any size.

Further, in each of the embodiments described above, all the threads which constitute the warp and weft were formed of aramid fiber. However, a part of these threads may be formed of resin fiber or cotton fiber other than the aramid fiber.

Further, in the embodiments described above, the explanation was given of the molding method of manufacturing the speaker-use diaphragm by impregnating the woven cloth with thermosetting resin to provide a prepreg and thereafter molding the prepreg into a predetermined shape by heating/cooling. However, this invention should not be limited to such a molding method. The speaker-use diaphragm can be manufactured by the molding method of injecting the thermosetting resin into a molding die in which the woven cloth is set so that the woven cloth is molded into a predetermined shape simultaneously with the injection molding.

1. A speaker-use diaphragm, comprising:
a woven cloth having warps and wefts, the woven cloth being impregnated with thermosetting resin and heat-molded to have a predetermined shape,
wherein each of the warps and wefts woven in the woven cloth is composed of a plurality of threads arranged in parallel.

2. The speaker-use diaphragm according to claim 1, wherein the threads constituting each of the warps and each of the wefts are at least two kinds of threads of different substances which are mixed.

3. A speaker-use diaphragm, comprising:
a woven cloth having warps and wefts, the woven cloth being impregnated with thermosetting resin and heat-molded to have a predetermined shape,
wherein each of the warps and wefts woven in the woven cloth is composed of a plurality of threads adjacently arranged in a plan view.

4. A speaker, comprising:
a diaphragm including a woven cloth having warps and wefts, the woven cloth being impregnated with thermosetting resin and heat-molded to have a predetermined shape,
wherein each of the warps and wefts woven in the woven cloth is composed of a plurality of threads arranged in parallel.
